(19) United States
(12) Patent Application Publication
(10) Pub. No.: US 2018/0285955 A1
(43) Pub. Date: Oct. 4, 2018

(54) METHOD FOR DIRECT TRANSACTION OF METAL SCRAPS THROUGH ENLARGED COLLECTION QUANTITIES

(71) Applicants: Tae Ho Lee, Seoul (KR); JOALOGIS CO., LTD., Gyeonggi-do (KR)

(72) Inventor: Tae Ho Lee, Seoul (KR)

(21) Appl. No.: 15/518,367

(22) PCT Filed: Aug. 1, 2016
(86) PCT No.: PCT/KR2016/008445

§ 371 Date: Apr. 11, 2017

(30) Foreign Application Priority Data
Aug. 25, 2015 (KR) 10-2015-0119846

(51) Int. Cl. G06Q 30/06; G06Q 50/28

(52) U.S. Cl. CPC G06Q 30/0627; G06Q 50/28

(57) ABSTRACT

There is provided a method for direct transaction of metal scrap through enlarged collection quantities that can increase profitability by enabling to calculate a conversion price in which a weight value on a weight basis and on timing basis of scraps formed in a large quantity is reflected while making small quantities secured by scrap dealers to a large quantity by collecting, to transmit the conversion price to each dealer, to determine a sale intention, to sell the scraps to several kinds of buyers, and to sell the scraps to a dealer, a middle merchant, and a large merchant with a highest price and that can enhance productivity while minimizing a management cost by providing a large quantity of scraps to steel companies.

### TECHNICAL FIELD

The present invention relates to a method for direct transaction of metal scrap through enlarged collection quantities that can contribute to profit increase of both a metal scrap dealer and a scrap consumer by increasing a collection quantity in a series of process of collecting metal scraps and delivering the metal scraps to a steel company.

### BACKGROUND

As well known, metal scraps are formed in various kinds, various materials, and various shapes of iron scraps generated in various production activities, molds used and discarded in various production activities, reinforcing bars and shape steels generated in a demolition building, and metal wastes such as a disused car and waste gas barrels or cans discharged in a consumption activity.

The metal scraps are collected, classified, cut in an appropriate size or are compressed, are guillotine shear and shedding processed, are melted in a revolving furnace or an electric furnace, and are produced into various steel products, thereby reducing a resource and energy used for producing the steel product and resultantly contributing to environment protection.

In this way, metal scraps formed with several forms and several materials are classified according to a material through basic classification, and compressed metal scraps may be shaped in a form and specification that may be immediately charged into a revolving furnace or an electric furnace by a steel company, which is a source of demand, a width, length, and height of the compressed metal scraps should be 600 mm to 2,100 mm and a density thereof should be compressed to 0.15 or more.

When producing such compressed metal scrap, a steel company conventionally classifies scraps collected through several routes into a ferrous metal scrap and a nonferrous metal scrap such as aluminum and copper, injects and presses the classified metal scraps into a compression apparatus, and shapes the metal scraps into a selected specification of polyhedral scraps, thereby shaping compressed metal scraps.

As can be seen in a corresponding portion (http://www.kosia.kr/iron/iron_05.php) of a home page of Korean steel scrap industry association, delivery of such metal scraps is performed as follows and is shown in FIG. 1. Providers classified into a so-called merchant for delivery of scrap purchase metal scraps collected by providers such as a small scale of peddlers, junk shop dealers, and middle merchants, collect an appropriate quantity of scraps, and deliver the scraps to a steel company.

Further, when scraps of a large quantity that can continuously inject are secured until operation of a revolving furnace or an electric furnace stops due to life-span termination of firebricks thereof, the steel company can obtain best operation efficiency and perform planned production and thus when scraps are delivered in mass, the steel company raises and pays a delivery unit cost.

However, in many cases in which a delivery quantity is not fully secured, delivery providers lower and pay a delivery unit cost due to a management and storage cost and thus profitability is lowered.

### DISCLOSURE

### Technical Problem

The present invention has been made in view of the above problems and provides a method for direct transaction of metal scrap through enlarged collection quantities that can increase profitability by enabling to calculate an optimal conversion price in which a weight value on a weight basis and on timing basis of scraps formed in a large quantity is reflected while making small quantities secured by scrap dealers in a large quantity by collecting, to transfer the optimal conversion price to each dealer, to determine a sale intention, to sell the scraps to several kinds of buyers, and to sell the scraps to a dealer, a middle merchant, and a large merchant with a highest price and that can enhance productivity while minimizing a cost of open field and management by providing a large quantity of scraps to steel companies.

### Technical Solution

In order to achieve such an object, when scrap collection dealers having a small secured quantity input related data such as a material, a grade, a quantity, a picture, and a contact phone number, a Web server classifies the related data on a material and grade basis and adds a quantity of the same material and grade, and accumulates such quantities to be a target quantity, and when the accumulated quantities become a target quantity, a conversion price, which is a price in which a weight value on a weight basis and on timing basis is reflected is calculated, the conversion price is notified to each dealer constituting a target quantity, and when a plurality of dealers transmit a sale intention, by providing data such as unit quantity information, price information, a contact phone number, a picture, a loading place, and a company name to a system manager, a middle merchant, a large merchant, an exporter, and a steel company, in order to perform transaction,

There is provided a method for direct transaction of metal scrap through enlarged collection quantities include: registering a specification of secured scraps at a Web server through terminals of each dealer; accumulating a target quantity on a material and grade basis of the scrap at the Web server through the dealer terminal; determining whether accumulation of a scrap target quantity of the same material and grade is complete at the Web server; transmitting, by the Web server, a conversion price per ton and a sale intention determination request to terminals of each dealer; receiving, by the Web server, a sale intention from terminals of each dealer within a limited time and determining a sale; transferring, by the Web server, target quantity information to a system manager, when transmitting a sale intention according to contents in which a sale intention is determined within a limited time at the receiving of a sale intention; notifying, by the Web server, a corresponding dealer terminal of transaction closing and increasing a quantity in a large quantity by collecting a corresponding quantity, when a purchase determination code of the system manager is input; announcing, by the Web server, a target quantity, when a purchase determination code of the system manager is not input; notifying, by the Web server, a corresponding dealer terminal and a purchase company terminal of transaction closing, when a purchase intention transmission company for an announced target quantity exists at the announcing of a target quantity; and notifying, by the Web server, the corresponding dealer terminal and the purchase company terminal of a transaction brokerage fee according to transaction closing.

### Advantageous Effects

According to the present invention, when a small scale of scrap delivery provider delivers scraps, by enabling the small scale of scrap delivery provider to directly deliver metal scraps of a large quantity in which a delivery company or a purchase company such as a steel company wants, the small scale of scrap delivery provider can obtain a high profit by large quantity delivery, efficient planned production and a cost of open storage and management of a steel company can be reduced and thus productivity can be enhanced.

Further, when a small amount of scattered scraps are registered, by immediately accumulating the scrap quantity, the scrap can be quickly delivered, pollution of a peripheral environment by open storage for a long period can be prevented, unnecessary loading, transfer, and unloading processes to a yard or a compression equipment can be omitted and thus environment pollution can be prevented and a scrap delivery related cost can be reduced.

Further, scraps can be directly transacted between a dealer and a purchase company of a foreign country, thereby enabling smooth supply and demand.

### BRIEF DESCRIPTION OF THE DRAWINGS

FIG. 1 is an iron scrap distribution status table;

FIG. 2 is an explanatory diagram illustrating basic hardware for executing the present invention; and

FIGS. 3, 4, and 5 are flowcharts illustrating a method for direct transaction of metal scrap through enlarged collection quantities according to another exemplary embodiment of the present invention.

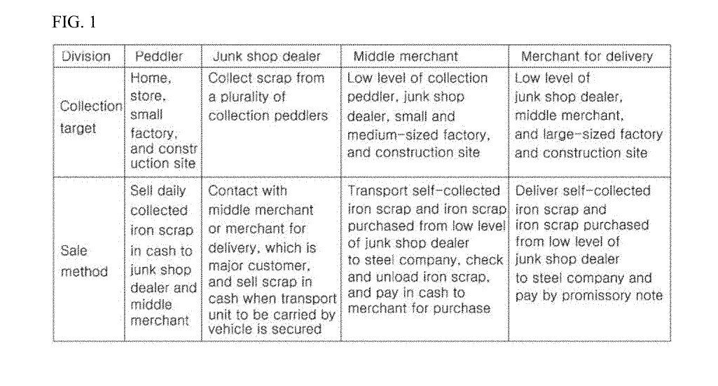

### BEST MODE

A method for direct transaction of metal scrap through enlarged collection quantities according to an exemplary embodiment of the present invention includes registering a specification of secured scrap at a Web server through terminals of each dealer,

accumulating a target quantity on a material and grade basis of the scrap at the Web server through the dealer terminal,

determining whether accumulation of a scrap target quantity of the same material and grade is complete at the Web server,

transmitting, by the Web server, a conversion price per ton and a sale intention determination request to each dealer terminal,

receiving, by the Web server, a sale intention from each dealer terminal within a limited time and determining a sale,

transferring, by the Web server, target quantity information to a system manager, when transmitting a sale intention according to contents in which a sale intention is determined within a limited time at the receiving of a sale intention;

announcing, by the Web server, a target quantity, when a purchase determination code of the system manager is not input,

notifying, by the Web server, a corresponding dealer terminal and a purchase company terminal of transaction closing, when a purchase intention transmission company for an announced target quantity exists at the announcing of a target quantity, and

notifying, by the Web server, a corresponding dealer terminal and a purchase company terminal of transaction brokerage according to transaction closing.

The receiving of a sale intention includes repeating to search for, by a Web server, when a sale rejection dealer exists, a quantity of the same condition as that of a corresponding quantity of the sale rejection dealer and to determine whether accumulation of a scrap target quantity of the same material and grade is complete.

When a purchase determination code of the system manager is input, the Web server notifies a corresponding dealer terminal of transaction closing, collects a corresponding quantity, and increases a favorite quantity of a steel company in a large quantity.

The method further includes calculating, by the Web server, a conversion price in which a weight value on a period basis is reflected between the determining of whether accumulation of a scrap target quantity of the same material and grade is complete and the transmitting of a conversion price per ton and a sale intention determination request.

### Detailed Description of Exemplary Embodiments

An exemplary embodiment of the present invention will be described in detail with reference to the accompanying drawings such that a person of ordinary skill in the art easily executes.

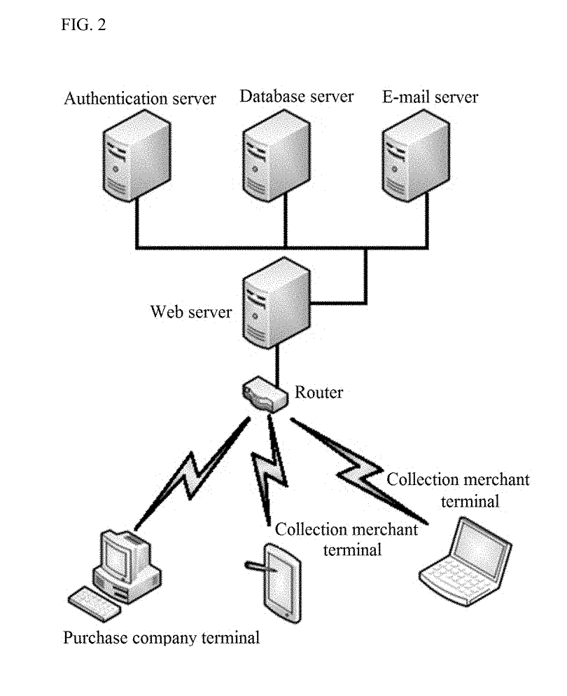

In the present invention, as shown in FIG. 2, a web site is constructed in which an authentication server, a database server, and a mail server are connected about a Web server, and a dealer terminal installed to a dealer that may be formed with a peddler, a junk shop dealer, a middle merchant, and a delivery merchant through an Internet network via a router, a terminal of a steel company as a purchase company, a delivery merchant terminal, and an exporter terminal are connected.

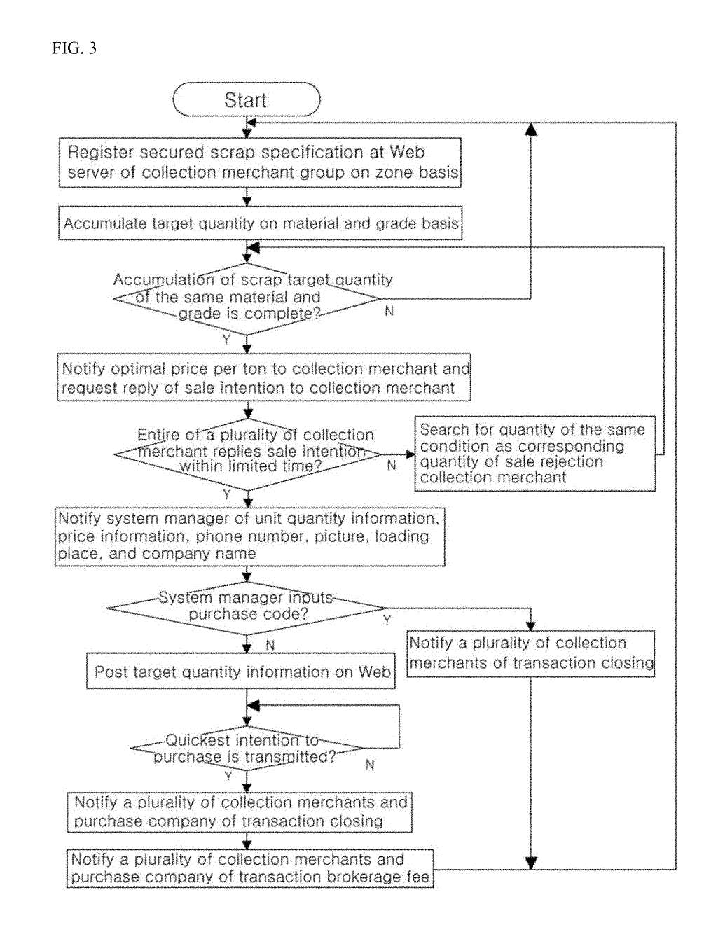

A method for direct transaction of metal scrap through enlarged collection quantities implemented by a web program loaded at a Web server based on such a hardware network will be described in detail with reference to FIG. 3.

In the present invention, a dealer terminal and a purchase company terminal, which are a subject that participates in an entire process from collection to demand of metal scrap should input data necessary for a form provided by a Web server and store the data at a database, and this is an essential process to be performed by an authentication server driven by a web program for reliability of information and stability of transaction and is a generally and widely universally executing step and therefore a description thereof will be omitted.

In the present invention, when terminals of dealers such as a peddler, a junk shop dealer, and a middle merchant having a small collection quantity are accessed to a website via a network such as Internet, the Web server divides the dealers on a zone basis based on the dealer's loading place and transmits related data such as a material, a grade, a quantity, a picture, and a contact phone number through an input window, and the dealers input data such as a material, a grade, a quantity, a picture, a loading place address, a phone number, and a company name of secured scraps through the input window.

For convenience of a purchase company, step of registering a secured scrap specification is performed at a Web server of a dealer group on a zone basis.

The Web server stores the scrap specification at a database server and collects and adds quantities of the scrap having the same material and grade, and until a time point in which a target quantity set by a system manager is accumulated, step of accumulating a target quantity on a material and grade basis is performed.

Further, step of determining whether accumulation of a target quantity on a material and grade basis is complete is performed, and in an initial state, because a target quantity is not accumulated, step of registering a secured scrap specification and subsequent steps at a Web server of the dealer group on a zone basis are repeatedly performed.

Step of accumulating a target quantity on a material and grade basis is performed in such a process, step of determining whether accumulation of a target quantity is completed is performed, and if accumulation of a target quantity is completed, a conversion price calculation step in which the ton number of a collection target quantity is multiplexed to a conversion price according to a weight transacted in the art is performed, and by dividing an obtained conversion price by the target quantity ton number, a conversion price per ton is calculated, and such a series of process may be implemented by a web program loaded at a Web server.

Thereafter, the Web server performs step of requesting a reply of a sale intention at an optimal conversion price per ton and within a limited time, such a step is performed in a form of transmitting a message through an e-mail server, and the same message should not be transmitted to a dealer, having already transmitted a sale intention, as described later.

Further, in the present invention, a sale intention transmitted from a dealer may be input by a method of clocking a radio button of a form provided at a Web server, may be input by a method of receiving a sign input, and may be replaced with a signature or seal figure, which is a drawing file.

A reply request message of a sale intention is transmitted to dealers constituting a target quantity in such a process and thus when the entire of each dealer transmits a sale intention to an e-mail server within a limited time, information such as sale quantity information, price information, a contact phone number, a scrap picture, a loading place, and a company name is transmitted to a system manager of a website according to the present invention, as described later.

However, when at least one of dealers constituting the target quantity transmits a sale rejection intention or does not transmit a sale intention within a limited time, it is searched for whether registration of a dealer who secures scrap of the same material and grade as a quantity of scrap registered by a sale rejection dealer exists and it is determined whether a scrap quantity of the same material and grade as a quantity of scrap in which a sale is rejected is accumulated and secured. As a result, when registration of another dealer who replaces a quantity of scrap in which a sale is rejected exists, as described above, the foregoing step of calculating a conversion price in which a weight value on a weight basis and on timing basis is reflected is performed, and a message that requests to transmit a calculated conversion price per ton and a sale intention within a limited time is transmitted only to a newly added dealer.

Accordingly, when a sale intention is transmitted from the entire dealer constituting a target quantity within a limited time, a sale quantity information transmission step that transmits information of a target quantity, a conversion price, a contact phone number, a picture, a loading place, and a company name to a system manager is performed.

As a result, when the system manager reviews entire information of a target quantity, a conversion price, and a picture and inputs a purchase determination code to the Web server, the Web server transmits a transaction closing message to a plurality of dealers constituting a target quantity via an e-mail server and scrap transfer and payment is performed in offline.

Further, because an intention to purchase does not exist, when the system manager inputs a purchase rejection code instead of a purchase determination code, step of posting target quantity information on a web that announces information such as a material, a grade, a quantity, a picture, a conversion price, a contact phone number, a loading place, and a company name of a target quantity through a webpage provided by the Web server is performed.

Accordingly, an intention to purchase is transmitted by a middle merchant or a delivery merchant who wants scrap purchase, an exporter that generally performs overseas export, or a steel company. When a company, having first transmitted an intention to transmit scrap exists, it is determined that there is a company which most quickly transmitted the intention of purchasing scrap, and for this reason, step of determining whether an intention to purchase is most quickly transmitted or not is performed, and such a process is repeated until a time point when a company first expressing the intention to purchase appears.

Further, when a company first expressing the intention to purchase exists, step of notifying a plurality of dealers and purchase companies is performed, in which the web program notifies a plurality of dealers and purchase companies constituting a target quantity of transaction closing.

After notifying the transaction closing, the web program transmits a predetermined transaction brokerage bill to a plurality of dealers and purchase companies via an e-mail server.

Further, the plurality of dealers and purchase companies receive scrap and pay for the bill offline, thereby terminating a series of process.

In the present invention, because metal scrap having a large weight is a target of transaction, a transport cost burden is very large, and it is preferable to divide transaction on a zone basis so as to minimize such a transport cost, but by enabling a middle merchant or a delivery merchant wanting to purchase scrap located at different regions, an exporter who generally performs overseas export, or a steel company to search for scrap quantity information frequently posted at a webpage, to select and change a zone, to transmit an intention to purchase, and to purchase metal scrap, as needed, nationwide transaction can be performed.

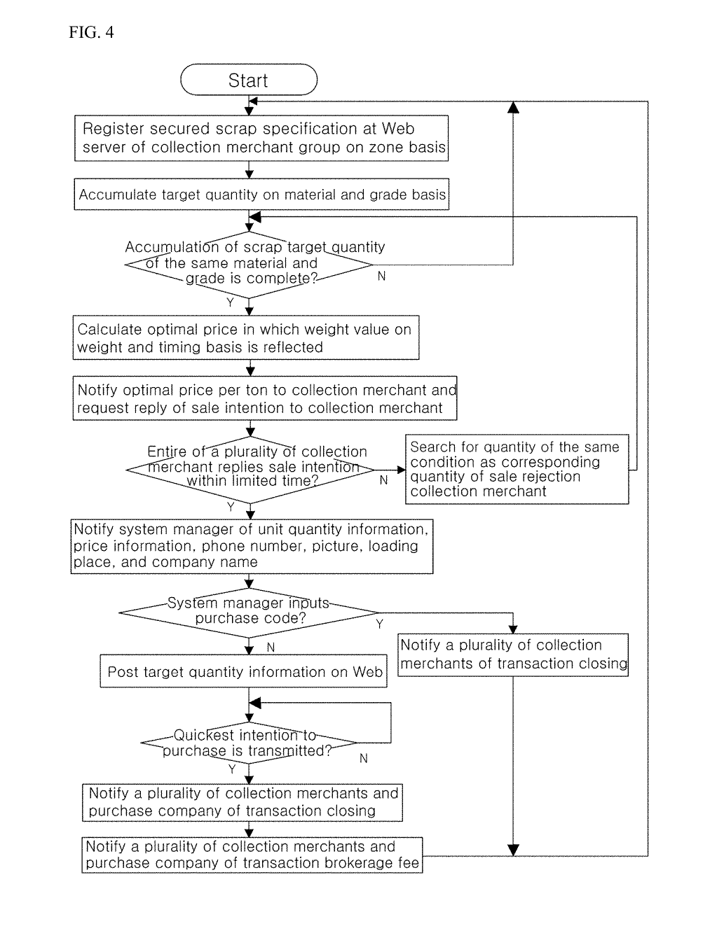

Particularly, in the present invention, as shown in FIG. 4, by calculating a conversion price in which a weight value on a weight basis and on timing basis is reflected between step of determining whether accumulation of a scrap target quantity of the same material and grade is complete and step of requesting a reply of an optimal conversion price per ton and a sale intention to a dealer, a highest profit can be provided to the dealer, and an enhanced additional value can be provided to a purchase company, and a steel company obtains a productivity improvement effect that secures scrap in a large quantity.

That is, in the present invention, as shown in FIG. 4, step of calculating a weight value reflection conversion price on a weight basis and on timing basis is performed, and first, at step of calculating a conversion price by reflecting a weight value on a weight basis, for example, a weight value of Table 1 on a weight basis may be given.

TABLE 1

Weight

| | 25 ton- | 300 ton- | 500 ton- | 1000 ton |
|---|---|---|---|---|
| | 299 ton | 499 ton | 999 ton | or more |
| Weight value | 1 | 1.03 | 1.05 | 1.10 |

When a weight value of Table 1 is applied, if a reference market price per ton is $400, a market price of a weight 250 ton becomes $100,000, and a market price of a weight 300 ton becomes $123,600, and thus when converting to the same quantity, profit increase of $3,600 occurs, compared with a segment in which a weight value is 1.

Further, a market price of a weight $600 ton becomes $252,000 with the same method, and when converting to the same quantity, profit increase of $12,000 occurs, similar to a segment in which a weight value is 1.

Further, in Table 1, when a weight of scraps is 2000 ton, a market price thereof becomes $880,000 and profit increase of $80,000 occurs, compared with a segment in which a weight value is 1.

Further, when a target quantity secured with the process and delivery hope timing suggested by a steel company or other sources of demand may be supplied, a weight value on timing basis is applied, and a preset system manager applies a preset weight value, and in most cases, a weight value on timing basis is generally set in a range of 1.1 (when a sale is not performed at a specific period, a loss expectation index is applied), and when a scrap weight is 2000 ton, a market price thereof becomes $880,000, when a weight value on timing basis is 1.1, a market price thereof becomes $968,000, and an additional value of $168,000 based on the same quantity is obtained and profit increase of 21% is obtained, compared with a case in which a market price of a quantity having no weight value is $800,000.

In the present invention, a conversion price, in which a weight value on a weight basis and on timing basis is reflected is calculated, that obtains a conversion price, which is a highest price calculated by applying a weight value on a weight basis and on timing basis calculated in this way.

Further, in the present invention, at step of notifying the plurality of dealers and purchase companies of transaction closing, by transmitting a contract content, a transaction documentary evidence for solving a lawful problem that may occur later between the persons directly involved may be provided.

Further, in the present invention, a website may be opened and operated in a nation unit with a language of a corresponding nation, and a website may be opened and operated using an international official language such as English and Spanish.

In this way, when opening and operating a website using an international official language, step in which a dealer group registers a secured scrap specification at a Web server should be divided and performed on a nation basis based on nationality of a loading place, and in this case, purchase companies of an entire nation that can be connected by an Internet network can participate to transaction and thus scrap transaction can be internationally activated.

Further, in such a case, a series of process of shipping scraps of a loading place at a foreign country to a vessel that carries to a home land may be performed.

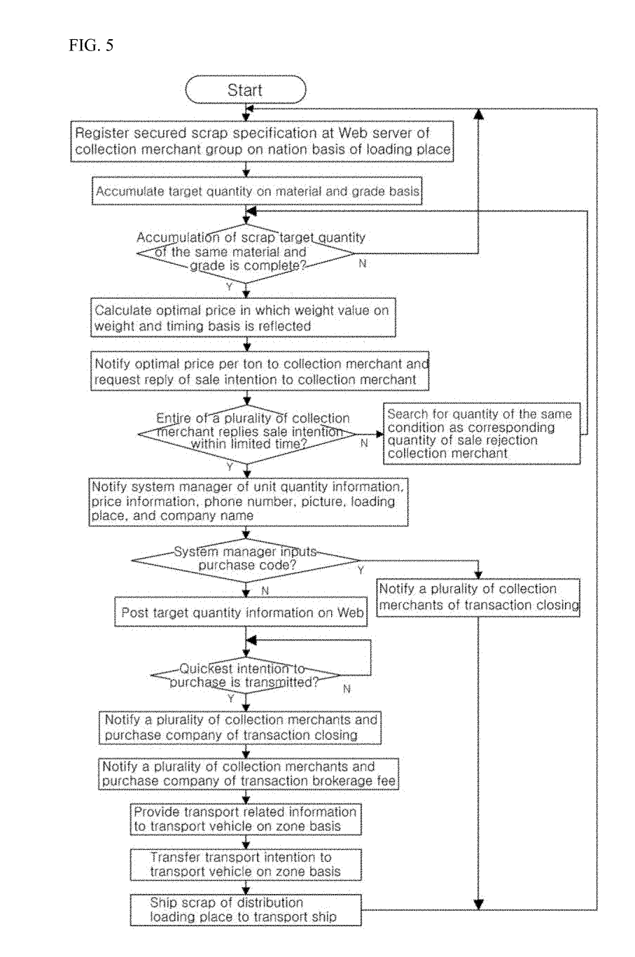

Therefore, as shown in FIG. 5, in the present invention, a system manager selectively provides conveyance related information such as a loading place, an unloading place, a transport period, and a freight charge to transporting vehicle drivers of a peripheral zone carrying a smart phone using a GPS function.

Accordingly, step of transmitting a message that ships scraps of a distributed loading place at a vessel in which currently driving or driving standby transporting vehicle drivers review conveyance related information, perform a transport contract step with the system manager via a transport intention transmitting step, carry scraps of a distributed located loading place, and ship the scraps at a vessel can be performed.

By enabling an oversea purchase company to conveniently ship and import metal scraps scattered at a foreign country at a vessel that carries the metal scraps to a home land with such a process, even in this case, a dealer can sale the metal scraps with a highest optimal price and thus increases a sale profit, and by enabling even a foreign company to purchase to import scrap in an internationally best condition, sale profit of the company can increase and thus an international scrap trade can be further activated.

Further, in the present invention, a target quantity is a variable concept and may be determined to an enough amount according to a request propensity and a price policy of a purchase company.

In the following description, a method for direct transaction of metal scrap through enlarged collection quantities according to the present invention is described together with the accompanying drawings, but illustrates an exemplary embodiment of the present invention and does not limit the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for direct transaction of metal scrap through enlarged collection quantities, the method comprising:
registering a specification of secured scraps at a Web server through terminals of each dealer;
accumulating a target quantity on a material and grade basis of the scrap at the Web server through the dealer terminal;
determining whether accumulation of a scrap target quantity of the same material and grade is complete at the Web server;
transmitting, by the Web server, a conversion price per ton and a sale intention determination request to the terminals of each dealer;
receiving, by the Web server, a sale intention from the terminals of each dealer within a limited time and determining a sale;
transferring, by the Web server, target quantity information to a system manager, when transmitting a sale intention according to contents in which a sale intention is determined within a limited time at the receiving of a sale intention;
announcing, by the Web server, a target quantity, when a purchase determination code of the system manager is not input;
notifying, by the Web server, a corresponding dealer terminal and a purchase company terminal of transaction closing, when a company having transmitted an intention of purchasing exists for a target quantity announced at the announcing of a target quantity; and
notifying, by the Web server, the corresponding dealer terminal and the purchase company terminal of a transaction brokerage fee according to the transaction closing.

2. The method of claim 1, wherein the registering of a specification comprises dividing and executing on a zone basis based on the dealer's loading place address.

3. The method of claim 1, wherein the receiving of a sale intention comprises repeating to search for, by a Web server, when a sale rejection dealer exists, a quantity of the same condition as that of a corresponding quantity of the sale rejection dealer and to determine whether accumulation of a scrap target quantity of the same material and grade is complete.

4. The method of claim 1, wherein the Web server notifies a corresponding dealer terminal of transaction closing, collects a corresponding quantity, and increases scrap in a large quantity, when a purchase determination code of the system manager is input.

5. The method of claim 1, further comprising repeating to determine, by the Web server, whether a purchase intention transmission company exists, when a purchase intention transmission company does not exist for an announced target quantity at the announcing of a target quantity.

6. The method of claim 1, further comprising calculating, by the Web server, a conversion price in which a weight value on a weight basis of a quantity is reflected between the determining of whether accumulation of a scrap target quantity of the same material and grade is complete and the transmitting of a conversion price per ton and a sale intention determination request.

7. The method of claim 1, further comprising calculating, by the Web server, a conversion price in which a weight value on a period basis is reflected between the determining whether accumulation of a scrap target quantity of the same material and grade is complete and the transmitting of a conversion price per ton and a sale intention determination request.

8. The method of claim 1, further comprising calculating, by the Web server, a conversion price in which a weight value on a weight basis and a weight value on a period basis are reflected between the determining of whether accumulation of a scrap target quantity of the same material and grade is complete and the transmitting of a conversion price per ton and a sale intention determination request.

9. The method of claim 6, wherein the Web server increases a weight value with increase of a weight based on a minimum weight, when the Web server calculates a conversion price in which a weight value on a weight basis is reflected.

10. The method of claim 9, wherein the Web server divides a weight segment that increases a weight value with increase of a weight into the plural and sets a weight value between 25 ton to 299 ton to 1, sets a weight value between 300 ton to 499 ton to 1.03, sets a weight value between 500 ton to 999 ton to 1.05, and sets a weight value between 1000 ton or more to 1.10, and the weight value gradually increases to a specific numerical value with increase of a weight.

11. The method of claim 1, wherein the notifying of a corresponding dealer terminal and a purchase company terminal of transaction closing comprises transmitting together contract content data.

12. The method of claim 1, wherein the registering of a specification comprises dividing and registering a specification on a nation basis based on nationality of a loading place, and a web site use language of the Web server is an international official language.

13. The method of claim 12, further comprising:
selectively providing conveyance related information comprising at least one of a loading place, an unloading place, a transport period, and a freight charge to transporting vehicle drivers on a peripheral zone basis carrying a smart phone accessed to the Web server and having a GPS function through the smart phone;
receiving a transport intention from the smart phone, having received conveyance related information through the selectively providing of conveyance related information; and
receiving, by the Web server, a shipping message in which scraps of distributed loading places are carried and are shipped at a vessel through the smart phone of the transporting vehicle driver, when scraps of distributed loading places are carried and are shipped at a vessel.
